(19) United States
(12) Patent Application Publication
(10) Pub. No.: US 2007/0182076 A1
(43) Pub. Date: Aug. 9, 2007

(54) Vibration isolator with reflective external travel restrictor and compressive snubber

(75) Inventors: Todd M. Wirges, Ann Arbor, MI (US); Donald P. Price, New Hudson, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partner, Plymouth, MI (US)

(21) Appl. No.: 10/567,297

(22) PCT Filed: Aug. 6, 2004
(86) PCT No.: PCT/US04/25503

§ 371 Date: Sep. 22, 2006

Related U.S. Application Data
(60) Provisional application No. 60/492,917, filed on Aug. 6, 2003.

(51) Int. Cl. F16F 13/00

(52) U.S. Cl. 267/140.13

(57) ABSTRACT

A vibration isolator mount (10) is provided including a travel restrictor (30) for limiting axial stretching of the spring component (22) to the vibration isolator mount. A snubber (32) ring is provided to provide a bumper between the travel restrictor (30) and a stop surface (12) in order to soften the impact therebetween when a heavy input occurs. Furthermore, the travel restrictor (30) is provided with a protective coating in order to reflect heat away from the isolator mount.

### CROSS-REFERENCE TO RELATED APPLICATIONS

This application claims the benefit of U.S. provisional application Ser. No. 60/492,917, filed on Aug. 6, 2003. The disclosure of the above application is incorporated herein by reference.

### FIELD OF THE INVENTION

The present invention relates to a vibration isolating device for use in vehicle powertrain mounting systems and more particularly, to a vibration isolating device having an external travel restriction element with or without a secondary reflective or otherwise radiant heat deflective coating, and a compressive snubber.

### BACKGROUND OF THE INVENTION

Many isolating devices permit unrestrained axial or radial travel of the isolation device, either in tension and/or in compression. Normally, axial or radial travel in the compression mode does not seriously affect the life of the device. However, stretching or axial tension in the isolation element can cause elongation of the material and ultimately failure of the isolation component.

This is especially important in hydraulic isolation or damping devices which have a pair of supporting members which are secured to a vibrating body and a frame. An elastomeric spring is disposed between the supporting members. A concave surface of the elastomeric spring and a rubber diaphragm, which is joined to the elastomeric spring, together define a liquid chamber filled with a (removed dampening) fluid, such as glycol or a similar fluid. A partition defines the liquid chamber which is divided into a main liquid chamber and an auxiliary liquid chamber. The partition has an opening which is closed with an elastic rubber wall. The partition is also provided with a throttle passageway which communicates with both the main liquid chamber and the auxiliary liquid chamber.

High frequency, low amplitude vibration is imparted into the main liquid chamber which absorbs most of the vibration via compliance of the elastic rubber wall. Low frequency, high damping forces cause the liquid in the main chamber to move into the auxiliary liquid chamber and thereby generating an out of phase damping system resulting in energy loss across the isolator. In the process, particularly in the low vibration, high damping modes, the elastomeric spring may be subjected to large axial or radial travel which imposes high compression and alternatively high tension forces in the isolation spring. These high (removed tension) forces in the elastomeric spring can lead to its premature failure.

Several devices have been proposed to solve this problem, such as U.S. Pat. No. 4,842,258, U.S. Pat. No. 5,178,374, and U.S. Pat. No. 5,501,433. All of these devices seek to limit both the axial stretching mode and the axial compression mode in the elastomeric spring. However, all of these devices are complicated and costly to make. Commonly assigned U.S. Pat. No. 6,250,615 discloses a vibration isolator with a tension restraint (travel restrictor) member that engages a stop member to limit the tension on the elastomeric spring member.

### SUMMARY OF THE INVENTION

Although the tension restraint member of U.S. Pat. No. 6,250,615has shown to be effective for limiting the high tension forces in the elastomeric spring member, the present invention provides a snubber or bumper for absorbing the impact forces between the travel restrictor and the stop surface. The present invention also has the benefit of fully controlling all compressive and tensile forces in both axial and radial displacements. Furthermore, the present invention provides for a secondary heat reflective external surface finish or coating on the travel restrictor for further reduction of heat imposed upon the isolator by the powertrain components.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of the vibration isolator according to the principal of the present invention;

FIG. 2 is a front perspective view of the vibration isolator according to the principles of the present invention;

FIG. 3 is a frontal side perspective view of the vibration isolator according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

The vibration isolator mount 10 of the present invention is utilized to locate and support a vehicle powertrain assembly as well as isolate powertrain induced vibration from the chassis of the vehicle. The vibration isolator mount 10 can be utilized for mounting and isolating vibrations between a vehicle engine, transmission, or other components thereof. The vibration isolator mount 10 acts to provide a vibration isolation device to control harmful vibration from being transmitted from the vehicle chassis to the powertrain or to isolate powertrain induced vibration from the chassis of the vehicle.

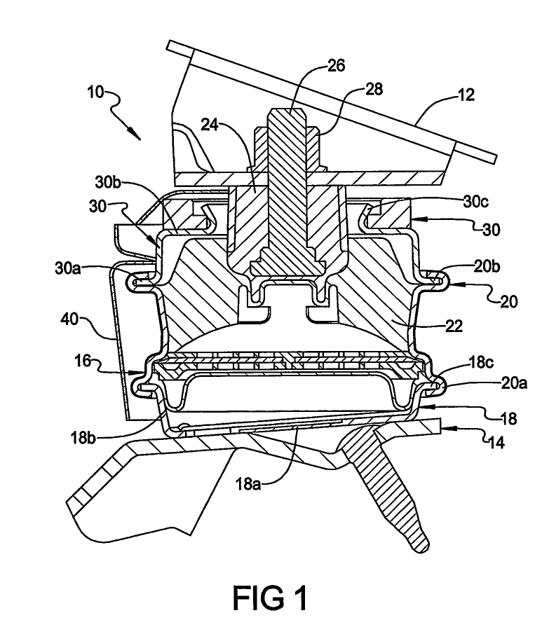

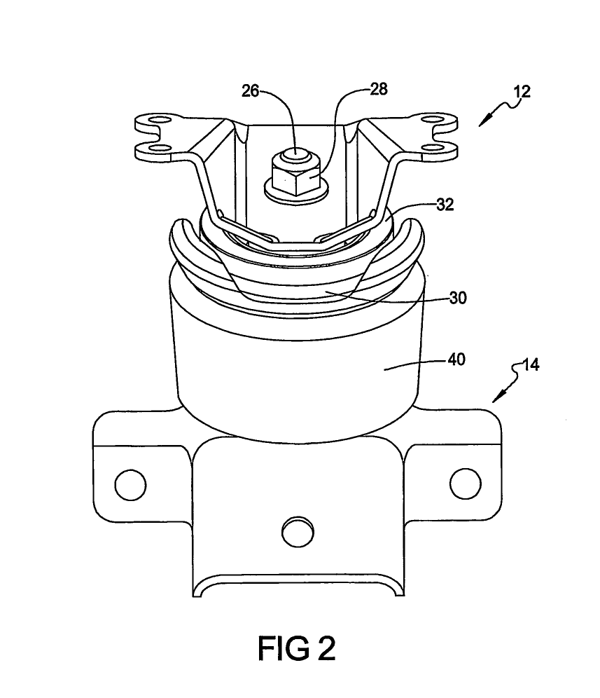

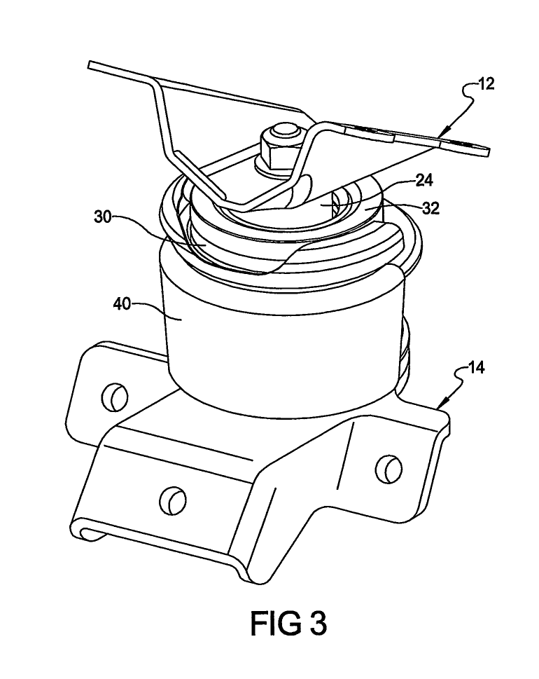

As shown in FIGS. 1-3, the vibration isolator mount assembly 10 is provided between a first engine side bracket 12 and a frame side bracket 14 with the engine side bracket 12 and frame side bracket 14 each serving as first and second support members.

The vibration isolator mount 10 includes a housing assembly 16 mounted to the frame side bracket 14 by a threaded fastener (not shown). The housing assembly 16 includes a lower housing member 18 including a base portion 18a, a side wall portion 18b extending from the base portion 18a and having a radially outwardly extending flange portion 18c extending from the side wall portion 18b. The housing assembly 16 also includes an upper casing member 20 having a lower flange portion 20a crimped around the radially extending flange portion 18C of the lower housing member 18. An elastomeric spring member 22 is molded to the upper casing member 20 and surrounding a core member 24. The core member 24 is mounted to the engine side bracket 12 by a threaded fastener 26 and nut 28. A travel restrictor 30 is mounted to the upper casing 20 and includes a radially extending flange portion 30a which is received in a crimped flange portion 20b provided at the upper end of the upper casing 20. The travel restrictor 30 includes a shoulder portion 30b which receives a snubber or bumper ring 32 thereagainst. The snubber 32 is preferably formed of an elastomeric material and is retained by a radially outwardly extending flange portion 30c of the travel restrictor 30.

The travel restrictor 30 is preferably coated with a reflective plating such as chrome, zinc, or nickel, although other coatings and platings can be utilized. Preferably, the coating or plating material is a light color, reflective material that is capable of reflecting heat away from the vibration isolator mount. A heat shield 34 is mounted adjacent to the vibration isolator mount 10, but use of additional reflective materials on the travel restrictor 30 will aid in protecting the vibration isolator mount 10 from heat generated by a nearby heat source such as an engine or exhaust system.

The snubber 32 provides an added bumper that is external to the housing 16 that absorbs the impact between the travel restrictor 30 and the lower surface of the engine side bracket 12. Because the snubber ring 32 is external to the housing, the snubber ring can be varied without affecting the manufacturing process to allow the ability to tune the stiffness of the overall vibration isolator mount. In other words, different snubbers can be utilized in different applications or in different locations within the same vehicle in order to provide the ability to specifically tune each vibration isolator mount to its specific environmental application. The design of the present invention provides the advantage of utilizing a secondary structural element to limit the travel of the vibration reduction mount's input interface. The lateral and axial travel are limited through the forming of the inside opening of the travel restrictor and the mount core 24. The snubber ring 32 limits compressive movement and provides a bumper for preventing hard contact between the travel restrictor 30 and the under surface of the engine side bracket 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vibration isolator for mounting between a pair of support members, comprising:
a core element adapted to be mounted to a first one of said pair of support members;
a housing assembly adapted to be mounted to a second one of said pair of support members;
an elastomeric spring member disposed between said housing assembly and said core element;
a travel restrictor connected to said housing assembly and surrounding said core element; and
an elastomeric bumper disposed adjacent to said travel restrictor and adapted to engage said first one of said pair of support members upon deflection of said elastomeric spring member.

2. The vibration isolator according to claim 1, wherein said travel restrictor is made from metal.

3. The vibration isolator according to claim 1, wherein said elastomeric bumper is generally ring shaped.

4. The vibration isolator according to claim 1, wherein said housing assembly includes a lower housing member adapted to be mounted to said second one of said pair of support members and an upper casing member, said travel restrictor being mounted to said upper casing member.

5. The vibration isolator according to claim 4, further comprising a nozzle plate assembly disposed between said elastomeric spring member and said lower housing member.

6. The vibration isolator according to claim 5, further comprising a diaphragm disposed between said nozzle plate assembly and said lower housing member.

7. The vibration isolator according to claim 1, wherein said travel restrictor is coated with a heat reflective material.

8. The vibration isolator according to claim 7, wherein said heat reflective material is selected from the group consisting of chrome, zinc or nickel platings.

9. The vibration isolator according to claim 1, wherein said travel restrictor and said housing assembly are crimped to one another.

10. The vibration isolator according to claim 1, wherein said travel restrictor has a shoulder portion against which said elastomeric bumper is disposed.

11. The vibration isolator according to claim 1, wherein said travel restrictor includes a retaining feature for engaging said elastomeric bumper.

12. A vibration isolator for mounting between a pair of support members, comprising:
a core element adapted to be mounted to a first one of said pair of support members;
a housing assembly adapted to be mounted to a second one of said pair of support members;
an elastomeric spring member disposed between said housing assembly and said core element;
a travel restrictor connected to said housing assembly and surrounding said core element, said travel restrictor being coated with a heat reflective material.

13. The vibration isolator according to claim 12, wherein said heat reflective material is selected from the group consisting of chrome, zinc or nickel platings.

14. The vibration isolator according to claim 12, wherein said housing assembly includes a lower housing member adapted to be mounted to said second one of said pair of support members and an upper casing member, said travel restrictor being mounted to said upper casing member.

15. The vibration isolator according to claim 14, further comprising a nozzle plate assembly disposed between said elastomeric spring member and said lower housing member.

16. The vibration isolator according to claim 15, further comprising a diaphragm disposed between said nozzle plate assembly and said lower housing member.
